(19) United States
(12) Patent Application Publication
(10) Pub. No.: US 2011/0109288 A1
(43) Pub. Date: May 12, 2011

(54) POWER CONVERTING CIRCUIT

(75) Inventors: Li-Min Lee, Taipei County (TW); Shian-Sung Shiu, Taipei County (TW); Chung-Che Yu, Taipei County (TW)

(73) Assignee: GREEN SOLUTION TECHNOLOGY CO., LTD., Taipei County (TW)

(21) Appl. No.: 12/891,812

(22) Filed: Sep. 28, 2010

(30) Foreign Application Priority Data
Nov. 6, 2009 (TW) 98137670

(51) Int. Cl. G05F 1/00

(52) U.S. Cl. 323/282

(57) ABSTRACT

A power converting circuit including a converting circuit and a controller is provided. In an embodiemnt of the invention, the inductance of the converting circuit and the operation frequency of the controller can be adjusted according to the power required by the load and/or the size of the inductor current to effectively reduce the switching times and the switching loss of the switch in the converting circuit when the load is light. Accordingly, no matter the load is light or heavy, the efficiency of the power converting circuit can be maintained at a higher standard.

### CROSS-REFERENCE TO RELATED APPLICATION

This application claims the priority benefit of Taiwan application serial no. 98137670, filed on Nov. 6, 2009. The entirety of the above-mentioned patent application is hereby incorporated by reference herein and made a part of this specification.

### BACKGROUND OF THE INVENTION

1. Field of the Invention

The invention generally relates to a power converting circuit, and more particularly, to a power converting circuit of which an inductance is adjusted with an inductor current.

2. Description of Related Art

FIG. 1 is a schematic circuit diagram of a conventional buck DC/DC converting circuit. Referring to FIG. 1, the buck DC/DC converting circuit is used to convert an input voltage Vin to a stable output voltage Vout to drive a load RL. The buck DC/DC converting circuit includes a controller Con, a switch SW, a diode D, an inductor L, a capacitor C, and a voltage detecting circuit VD. The voltage detecting circuit VD is used to generate a voltage feedback signal VFB. The controller Con is used to generate a control signal S to turn on or cut off the switch SW according to the voltage feedback signal VFB, so that the output voltage Vout is stabilized at a predetermined voltage. The load RL is connected to the buck DC/DC converting circuit, and a load current Iload flows the load.

FIG. 2 shows a relationship between the load current, the operation frequency and the inductance of the buck DC/DC converting circuit shown in FIG. 1. As shown in figure, the operation frequency of the control signal S outputted by the controller Con and the inductance of the inductor L are constant within a general operation region, and they do not change with the load current Iload, i.e. the loading of the load RL (light or heavy).

The above design of the circuit having the constant operation frequency and the constant inductance is simple, and it is easy to filter electromagnetic interference (EMI). However, when the load is light, the efficiency of the converting circuit is low due to the large switching loss of the switch.

### SUMMARY OF THE INVENTION

In the prior art, when the load is light, the efficiency of the buck DC/DC converting circuit with constant frequency and inductance is low. Accordingly, in an embodiment of the invention, the inductance of the converting circuit and the operation frequency of the controller are adjusted according to the power required by the load and/or the size of the inductor current to effectively reduce the switching times and the switching loss of the switch in the converting circuit when the load is light, so that no matter the load is light or heavy, the efficiency of the power converting circuit can be maintained at a higher standard.

An embodiment of the invention provides a power converting circuit including a converting circuit and a controller. The converting circuit is used to convert an input voltage to an output voltage to drive a load, and the converting circuit includes an inductance unit. The controller controls the converting circuit to convert the input voltage to the output voltage. Herein, the inductance of the inductance unit decreases as the current flowing through the inductance unit increases.

Another embodiment of the invention also provides a power converting circuit including a converting circuit and a controller. The converting circuit is used to convert an input voltage to an output voltage to drive a load, and the converting circuit having an equivalent inductance. The controller controls the converting circuit to convert the input voltage to the output voltage. Herein, the equivalent inductance decreases as the power required by the load increases.

It is to be understood that both the foregoing general description and the following detailed description are exemplary, and are intended to provide further explanation of the invention as claimed. In order to make the features and the advantages of the present invention comprehensible, exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit diagram of a conventional buck DC/DC converting circuit.

FIG. 2 shows a relationship between the load current, the operation frequency and the inductance of the buck DC/DC converting circuit shown in FIG. 1.

FIG. 3A is a schematic circuit diagram of a power converting circuit according to a first embodiment of the invention.

FIG. 3B shows a relationship between the inductance and the inductor current of the inductance unit shown in FIG. 3A.

FIG. 4 is a schematic circuit diagram of a power converting circuit according to a second embodiment of the invention.

FIG. 5 is a schematic circuit diagram of a power converting circuit according to a third embodiment of the invention.

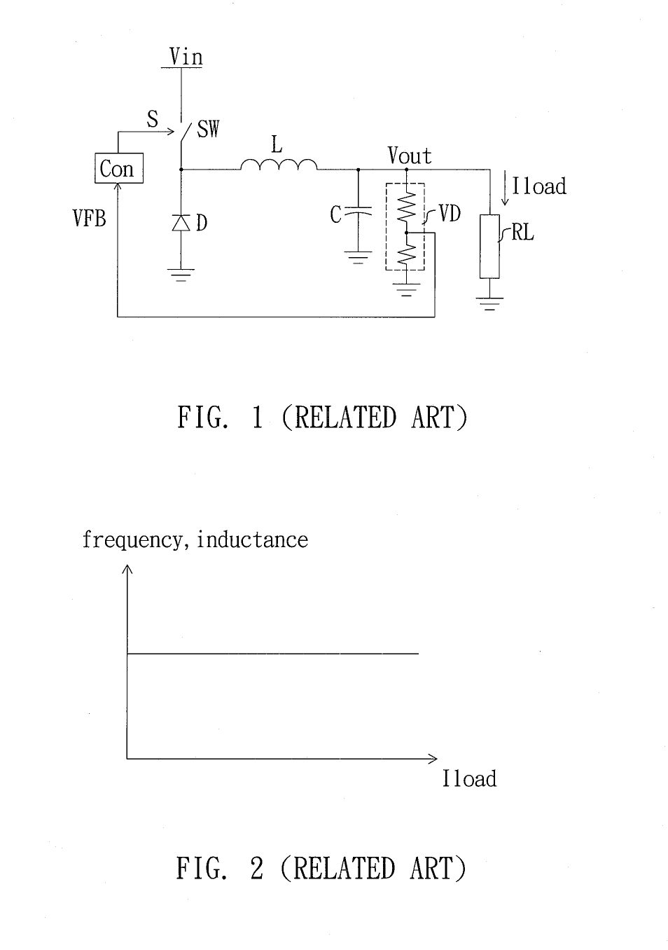

### DESCRIPTION OF EMBODIMENTS

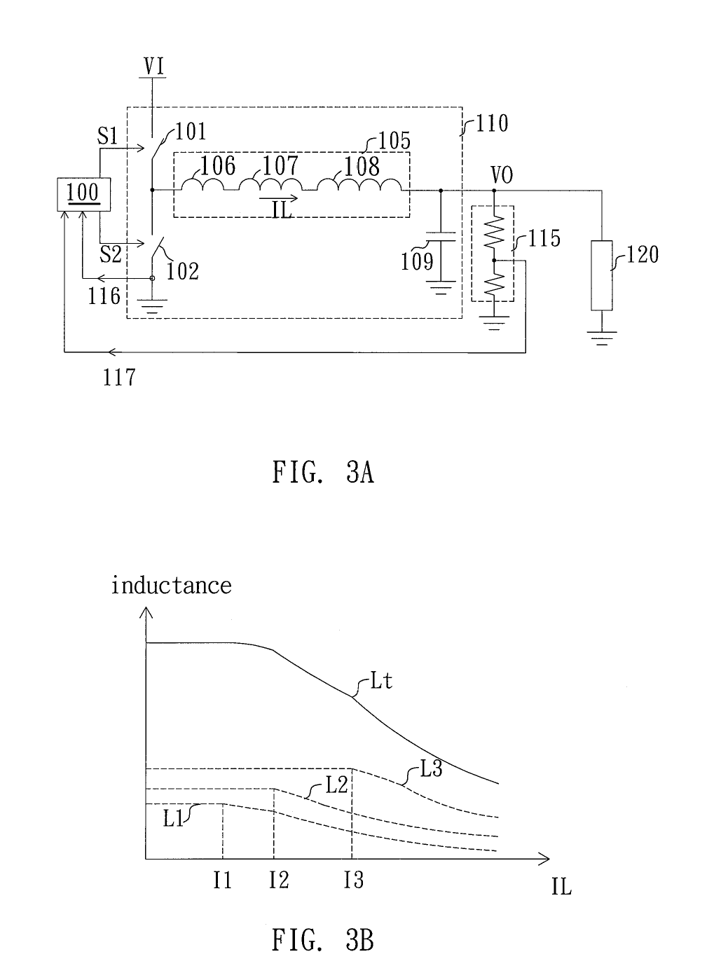

FIG. 3A is a schematic circuit diagram of a power converting circuit according to a first embodiment of the invention. In the present embodiment, the power converting circuit is a buck DC/DC converting circuit including a controller 100 and a converting circuit 110. The converting circuit 110 includes a first switch 101, a second switch 102, an inductance unit 105, and an output capacitor 109. The converting circuit 110 is used to convert an input voltage VI to an output voltage VO to drive a load 120. Herein, the inductance of the inductance unit 105 decreases as the current IL flowing through the inductance unit 105 increases within a current rating of the power converting circuit. The size of the current IL of the inductance unit 105 changes with the power required by the load 120. Accordingly, the inductance of the inductance unit 105 also decreases as the power required by the load 120 increases. In the present embodiment, the inductance unit 105 is formed by three inductors 106, 107, and 108 coupled in series, and each of them has a different saturation current value. FIG. 3B shows a relationship between the inductance and the inductor current of the inductance unit shown in FIG. 3A. Referring to FIG. 3A and FIG. 3B, the inductors 106, 107, and 108 respectively have inductances L1, L2, and L3, and the saturation current values thereof are respectively I1, I2, and I3. Accordingly, the equivalent inductance Lt of the inductance unit 105 is the summation of the inductances L1, L2, and L3 of the inductors 106, 107, and 108. The relationship between the equivalent inductance Lt and the inductor current is changed with the inductors having different characteristics, which form the inductance unit. However, no matter what relationship they are, such as the linear relationship, the step-like relationship, the relationship as the curve in the present embodiment, or other relationship that the inductance decreases as the inductor current increases, it can be applied to the invention without affecting the advantage of the invention.

The controller 100 generates a first control signal S1 to turn on the first switch 101 according to a voltage feedback signal 117 which is generated by a voltage feedback circuit 115 and represents the output voltage VO. Accordingly, when the output voltage VO is lower than a predetermined voltage, the input voltage VI transmits electric power to the output capacitor 109 and the load 120 through the first switch 101, and thereby the output voltage VO is raised. When the first switch 101 is cut off, the controller 100 outputs a second control signal S2 to turn on the second switch 102, so that the current of the inductance unit 105 forms a current loop through the second switch 102 to release the electric power stored in the inductance unit 105, and the controller 100 determines to cut off the second switch 102 according to a current detecting signal 116, which represents the size of the current following through the second switch 102, when the current of the second switch 102 is smaller than a predetermine value. With repeating the above operation, the objective that stabilizes the output voltage VO at the predetermined voltage can be achieved.

In the invention, when the load of the power converting circuit is light, the equivalent inductance in the converting circuit is raised. A higher inductance lowers the rate of the inductor current changing with the time. Accordingly, compared with the prior art, when the load of the power converting circuit in the invention is light, the inductor current is smaller, so that the switching loss is reduced. Therefore, no matter the load of the power converting circuit in the invention is light or heavy, the efficiency of the circuit can be maintained at a higher standard.

Besides the above buck DC/DC converting circuit, the power converting circuit in the invention can also be applied to other power converting circuit, such as a boost converting circuit, a buck-boost converting circuit, a flyback converting circuit, a forward converting circuit, a half bridge converting circuit, or a full bridge converting circuit. In following, another embodiment will be described to illustrate a different power converting circuit applied to different application.

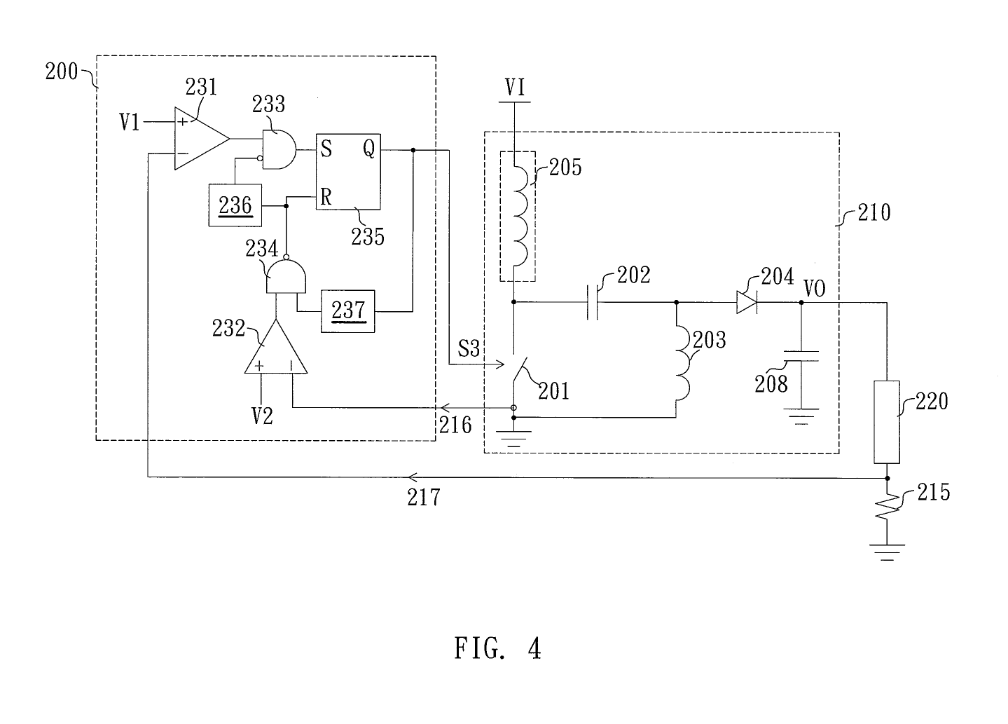

FIG. 4 is a schematic circuit diagram of a power converting circuit according to a second embodiment of the invention. Referring to FIG. 4, in the present embodiment, the power converting circuit is a buck-boost converting circuit including a controller 200 and a converting circuit 210. The converting circuit 210 includes a switch 201, a first capacitor 202, an inductor 203, a diode 204, an inductance unit 205, and an output capacitor 208. The converting circuit 210 is used to buck/boost an input voltage VI to an output voltage VO to drive a load 220. Herein, the inductance of the inductance unit 205 decreases as the current of the inductance unit 205 (or the power required by the load 220) increases. The inductor 203 may be an inductor with a constant inductance or an inductor with an inductance changing with the inductor current as the inductance unit 205.

The controller 200 is a constant on time controller which generates a third control signal S3 to turn on or cut off the switch 201 according to a current feedback signal 217 generated by a current feedback circuit 215 and representing the current flowing through the load 220 and according to a current detecting signal 216 representing the current flowing through the switch 201. Accordingly, the current flowing through the load 220 is stabilized at a predetermined current. The controller 200 includes a first comparator 231, a second comparator 232, an AND gate 233, a NAND gate 234, a SR latch 235, a shortest off time control unit 236, and a constant on time control unit 237. When the current feedback signal 217 is lower than a first reference level V1, the first comparator 231 outputs a high level signal to trigger the SR latch 235 to output the control signal S3 with a high level from the Q end, thereby turning on the switch 201. In the meanwhile, the inductance unit 205 stores the electric power from the input voltage VI.

When receiving the control signal S3 with the high level, the constant on time control unit 237 generates a constant time pulse signal. The second comparator 232 receives the current detecting signal 216 and a second reference level, and when the current detecting signal 216 is lower than the second reference level V2, i.e. the current flowing through the switch 201 is not higher than a predetermined over current protection value, the second comparator 232 generates a high level signal. When the current flowing through the switch 201 is higher than the predetermined over current protection value, the second comparator 232 outputs a low level signal. When the second comparator 232 and the constant on time control unit 237 both output the high level signals, the NAND gate 234 outputs the low level signal. After the constant on time control unit 237 outputs the high level signal for a constant time, the NAND gate 234 outputs the high level signal so that the control signal S3 is switched to a low level signal. In the meanwhile, the switch 201 is cut off, and the electric power stored in the inductance unit 205 is released and then respectively stored in the inductor 203 and the output capacitor 208 through the first capacitor 202 and the diode 204. The electric power stored in the inductor 203 is restored to the first capacitor 202 through the switch 201 later. If the current of the switch 201 is higher than the predetermined over current protection value within the duration that the constant on time control unit 237 outputs the high level signal, the second comparator 232 outputs the low level signal so that the NAND gate 234 outputs the high level signal. In the meanwhile, the control signal S3 of the SR latch 235 becomes low level to cut off the switch 201, thereby achieve the over current protection.

When receiving the high level signal outputted by the NAND gate 234, the shortest off time control unit 236 outputs a predetermined shortest off time pulse signal, and the predetermined shortest off time pulse signal is inputted to the AND gate 233 after being inverted. When the load 220 is heavy, the current flowing through the load 220 can not return above the predetermined current or stays above the predetermined current for a very short time, so that the first comparator 231 is almost maintained to output the high level signal. In the meanwhile, the shortest off time control unit 236 keep the SR latch 235 to output the control signal S3 with the low level for the predetermined shortest off time, so that the inductance unit 205 has the time for releasing the electric power.

Besides the above constant on time controller, other controllers capable of modulating frequency can be used in the embodiment of the invention, such as a constant off time controller, a PWM/PFM (pulse width modulation mode and pulse frequency modulation mode) switch controller, or a controller having a skip mode. The controller adjusts operation frequency with the power required by the load, so that the switching times are reduced when the load is light, thereby enhancing the efficiency of the circuit.

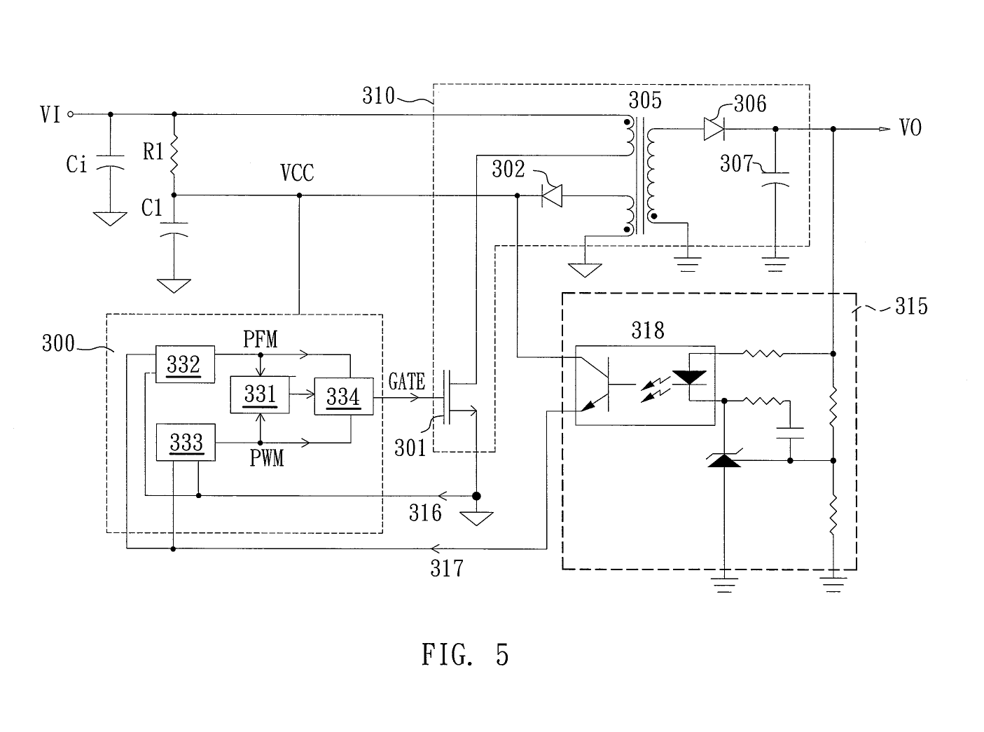

FIG. 5 is a schematic circuit diagram of a power converting circuit according to a third embodiment of the invention. Referring to FIG. 5, in the present embodiment, the power converting circuit is a flyback converting circuit including a controller 300 and a converting circuit 310. The converting circuit 310 includes a transistor switch 301, a first diode 302, a transformer unit 305, a second diode 306, and an output capacitor 307. The converting circuit 310 is used to convert an input voltage VI to an output voltage VO to drive a load (not shown). Generally, the input voltage VI is rectified by a bridge rectifier to form an AC voltage. Accordingly, the converting circuit 310 can further include an input rectification capacitor Ci to make the input voltage VI more stable. Furthermore, the transformer unit 305 includes transformers having air gaps. By adjusting the width of the air gap, the transformer can have different inductances, and by the different inductances, the inductances of the transformer unit 305 which decreases as the current flowing through the transformer unit 305 (or the power required by the load) increases can be formed.

In the present embodiment, the controller 300 is a PWM/PFM switch controller which generates a control signal GATE to turn on or cut off the transistor switch 301 according to a current feedback signal 317 generated by a voltage feedback circuit 315 and representing the output voltage VO, and according to a current detecting signal 316 representing the current flowing through the transistor switch 301. Accordingly, the output voltage VO is stabilized at a predetermined voltage. The controller 300 includes a PWM/PFM switch unit 331, a PFM unit 332, a PWM unit 333, and a driving unit 334. The PFM unit 332 and the PWM unit 333 respectively generate a pulse frequency modulated signal PFM and a pulse width modulated signal PWM according to the current detecting signal 316 and the current feedback signal 317, and respectively output them to the PWM/PFM switch unit 331 and the driving unit 334. The PWM/PFM switch unit 331 determines the controller 300 to operate in the PWM mode or in the PFM mode according to the signals PFM and PWM, and accordingly, the driving unit 334 selects one of the signals PFM and PWM and outputs the selected one as the control signal GATE. Hence, the controller 300 operates in the PWM mode when the load is heavy, and operates in the PFM mode when the load is light.

Furthermore, through the resistor R1 and the capacitor C1, the driving voltage VCC can be provided to the controller 300, and after the converting circuit 310 operates, the driving voltage VCC can be provided through the auxiliary coil of the transformer unit 305 after being rectified by the first diode 302. In order to electrically isolate the primary coil and the secondary coil of the transformer unit 305 to satisfy the safety regulation, the voltage feedback circuit 315 can include an optical coupler 318 to achieve the electrical isolation.

To sum up, when the load of the power converting circuit is light, the equivalent inductance in the converting circuit is raised, so that the inductor current is smaller, so that the switching loss reduced. Therefore, no matter the load of the power converting circuit is light or heavy, the efficiency of the circuit can be maintained at a higher standard.

As the above description, the invention completely complies with the patentability requirements: novelty, non-obviousness, and utility. It will be apparent to those skilled in the art that various modifications and variations can be made to the structure of the present invention without departing from the scope or spirit of the invention. In view of the foregoing descriptions, it is intended that the present invention covers modifications, and variations of this invention if they fall within the scope of the following claims and their equivalents.

What is claimed is:

1. A power converting circuit, comprising:
a converting circuit converting an input voltage to an output voltage to drive a load, and the converting circuit comprising an inductance unit; and
a controller controlling the converting circuit to convert the input voltage to the output voltage,
wherein an inductance of the inductance unit decreases as a current flowing through the inductance unit increases.

2. The power converting circuit as claimed in claim 1, wherein the inductance unit comprises a plurality of inductors coupled in series.

3. The power converting circuit as claimed in claim 2, wherein the inductors have different saturation current values.

4. The power converting circuit as claimed in claim 2, wherein the converting circuit is a boost converting circuit, a buck converting circuit, a buck-boost converting circuit, a flyback converting circuit, a forward converting circuit, a half bridge converting circuit, or a full bridge converting circuit.

5. The power converting circuit as claimed in claim 2, wherein the controller is a constant on time controller, a constant off time controller, a PWM/PFM (pulse width modulation mode and pulse frequency modulation mode) switch controller, or a controller having a skip mode.

6. The power converting circuit as claimed in claim 2, wherein an operation frequency of the controller increases as a power required by the load increases.

7. The power converting circuit as claimed in claim 1, wherein the controller outputs at least one control signal to control the converting circuit, and the controller adjusts an operation frequency of the least one control signal, so that the operation frequency increases as a power required by the load increases.

8. The power converting circuit as claimed in claim 7, wherein the converting circuit is a boost converting circuit, a buck converting circuit, a buck-boost converting circuit, a flyback converting circuit, a forward converting circuit, a half bridge converting circuit, or a full bridge converting circuit.

9. The power converting circuit as claimed in claim 7, wherein the controller is a constant on time controller, a constant off time controller, a PWM/PFM (pulse width modulation mode and pulse frequency modulation mode) switch controller, or a controller having a skip mode.

10. A power converting circuit, comprising:
a converting circuit converting an input voltage to an output voltage to drive a load, and the converting circuit having an equivalent inductance; and
a controller controlling the converting circuit to convert the input voltage to the output voltage,
wherein the equivalent inductance decreases as a power required by the load increases.

11. The power converting circuit as claimed in claim 10, wherein the converting circuit comprises a plurality of inductors coupled in series.

12. The power converting circuit as claimed in claim 11, wherein the inductors have different saturation current values.

13. The power converting circuit as claimed in claim 11, wherein the converting circuit is a boost converting circuit, a buck converting circuit, a buck-boost converting circuit, a flyback converting circuit, a forward converting circuit, a half bridge converting circuit, or a full bridge converting circuit.

14. The power converting circuit as claimed in claim 11, wherein the controller is a constant on time controller, a constant off time controller, a PWM/PFM (pulse width modulation mode and pulse frequency modulation mode) switch controller, or a controller having a skip mode.

15. The power converting circuit as claimed in claim 11, wherein an operation frequency of the controller, increases as the power required by the load increases.

16. The power converting circuit as claimed in claim 10, wherein the controller outputs at least one control signal to control the converting circuit, and the controller adjusts an operation frequency of the least one control signal, so that the operation frequency increases as the power required by the load increases.

17. The power converting circuit as claimed in claim 16, wherein the converting circuit is a boost converting circuit, a buck converting circuit, a buck-boost converting circuit, a flyback converting circuit, a forward converting circuit, a half bridge converting circuit, or a full bridge converting circuit.

18. The power converting circuit as claimed in claim 16, wherein the controller is a constant on time controller, a constant off time controller, a PWM/PFM (pulse width modulation mode and pulse frequency modulation mode) switch controller, or a controller having a skip mode.

19. The power converting circuit as claimed in claim 10, wherein the converting circuit comprises a transformer having an air gap.
